(19) United States
(12) Patent Application Publication
(10) Pub. No.: US 2016/0171293 A1
(43) Pub. Date: Jun. 16, 2016

(54) GESTURE TRACKING AND CLASSIFICATION

(71) Applicant: THE UNIVERSITY OF WARWICK, West Midlands (GB)

(72) Inventors: Chang-Tsun Li, Warwickshire (GB); Yi Yao, West Midlands (GB)

(73) Assignee: The University of Warwick, West Midlands (US)

(21) Appl. No.: 14/779,835

(22) PCT Filed: Mar. 28, 2014
(86) PCT No.: PCT/GB2014/050996

§ 371 Date: Sep. 24, 2015

(30) Foreign Application Priority Data
Mar. 28, 2013 (GB) 1305812.8

(51) Int. Cl. G06K 9/00; G06T 7/00; G06K 9/40; G06K 9/62; G06T 7/20; G06T 7/40; G06K 9/46

(52) U.S. Cl. CPC G06K 9/00335; G06T 7/408; G06T 7/0081; G06K 9/4652; G06K 9/6202; G06T 7/204; G06K 9/40; G06K 9/6277; G06T 2207/10024

(57) ABSTRACT

A method of tracking the position of a body part, such as a hand, in captured images, the method comprising capturing (10) colour images of a region to form a set of captured images; identifying contiguous skin-colour regions (12) within an initial image of the set of captured images; defining regions of interest (16) containing the skin-coloured regions; extracting (18) image features in the regions of interest, each image feature relating to a point in a region of interest; and then, for successive pairs of images comprising a first image and a second image, the first pair of images having as the first image the initial image and a later image, following pairs of images each including as the first image the second image from the preceding pair and a later image as the second image: extracting (22) image features, each image feature relating to a point in the second image; determining matches (24) between image features relating to the second image and image features relating to in each region of interest in the first image; determining the displacement within the image of the matched image features between the first and second images; disregarding (28) matched features whose displacement is not within a range of displacements; determining regions of interest (30) in the second image containing the matched features which have not been disregarded; and determining the direction of movement (34) of the regions of interest between the first image and the second image.

This invention relates to methods of tracking and classifying gestures, such as, non exclusively hand gestures, and to related computing apparatus.

Gesture recognition, such as hand gesture recognition, is an intuitive way for facilitating Human Computer Interaction (HCI). Typically, a camera coupled to a computer captures images to be analysed by the computer to determine what gesture a subject is making. The computer can then act dependent upon the determined gesture. However, the robustness of hand gesture recognition against uncontrolled environments is widely questioned. Many challenges exist in real-world scenarios which can largely affect the performance of appearance based methods, including presence of cluttered background, moving objects in foreground and background, gesturing hand out of the scene, pause during the gesture, and presence of other people or skin-coloured regions, etc. This is the reason why the majority of works in hand gesture recognition are only applicable in controlled environments (e.g., environment where no interference is possible or where the performer's position is fixed so that the performing hands are always in sight).

There have been few attempts for recognising hand gestures in different uncontrolled environments. Bao et al. (Jiatong Bao, Aiguo Song, Yan Guo, Hongru Tang, “Dynamic Hand Gesture Recognition Based on SURF Tracking”, International Conference on Electric Information and Control Engineering—ICEICE (2011)) proposed an approach using the feature recognition algorithm SURF (Herbert Bay, Andreas Ess, Tinne Tuytelaars, Luc Van Gool, “SURF: Speeded-Up Robust Features”, Computer Vision and Image Understanding (CVIU), Vol. 110, No. 3, pp. 346-359, (2008)) as features to describe hand gestures. The matched SURF point pairs between adjacent frames are used to produce the hand movement direction.

This method only works under the assumption that the gesture performer occupies a large proportion of the scene. If there are any other moving objects at the same scale of the gesture performer in the background, the method will fail.

Elmezain et al. (Mahmoud Elmezain, Ayoub Al-Hamadi, Bernd Michaelis, “A Robust Method for Hand Gesture Segmentation and Recognition Using Forward Spotting Scheme in Conditional Random Fields”, International Conference on Pattern Recognition—ICPR, pp. 3850-3853, (2010)) proposed a method which segments hands from the complex background using a 3D depth map and colour information. The gesturing hand is tracked by using Mean-Shift and Kalman filter. Fingertip detection is used for locating the target hand. However, this method can only deal with the cluttered background and is unable to cope with other challenges mentioned earlier.

Alon et al. (J. Alon, V. Athitsos, Q. Yuan and S. Sclaroff. “A Unified Framework for Gesture Recognition and Spatiotemporal Gesture Segmentation”, IEEE Transactions on Pattern Analysis and Machine Intelligence (PAMI), pp. 1685-1699, September (2009)) proposed a framework for spatiotemporal gesture segmentation. Their method is tested in uncontrolled environments with other people moving in the background. This method tracks a certain number of candidate hand regions. The number of candidate regions can largely affect the performance of the method, which must be specified beforehand, making it unrealistic in real-world scenarios.

As such, it is desirable to improve the accuracy with which hand gestures can be tracked and classified in uncontrolled environments.

According to a first aspect of the invention, there is provided a method of tracking the position of a body part, such as a hand, in captured images, the method comprising:
capturing colour images of a region to form a set of captured images;
identifying contiguous skin-colour regions within an initial image of the set of captured images;
defining regions of interest containing the skin-coloured regions;
extracting image features in the regions of interest, each image feature relating to a point in a region of interest;
and then, for successive pairs of images comprising a first image and a second image, the first pair of images having as the first image the initial image and a later image, following pairs of images each including as the first image the second image from the preceding pair and a later image as the second image:
extracting image features, each image feature relating to a point in the second image;
determining matches between image features relating to the second image and image features relating to in each region of interest in the first image;
determining the displacement within the image of the matched image features between the first and second images;
disregarding matched features whose displacement is not within a range of displacements;
determining regions of interest in the second image containing the matched features which have not been disregarded;
determining the direction of movement of the regions of interest between the first image and the second image.

Thus, we provide a method of tracking a body part in an image, which will track those areas which were skin coloured in the initial frame; this allows the method to discriminate against other skin-coloured areas being introduced later. Furthermore, as features that do not have the required displacement between (temporally spaced) frames are disregarded, the method can ignore features that are moving either too slow to be considered as part of a gesture (therefore allowing the method to concentrate on the parts of the image that are moving) or too fast to be considered as part of a gesture (and hence would otherwise lead to erroneous data). Finally, the output of the method is a path comprising directional data, with a direction being given per pair for each region of interest. This allows the method to be more tolerant of the speed with which the subject moves their body part, as the output for each frame is independent of the speed with which the body part is moved.

The step of identifying the skin-colour regions may comprise identifying those regions of the image that are within a skin region of a colour space. The skin region may be predetermined, in which case the skin region will be set to include a likely range of skin tones. Alternatively, the skin region may be determined by identifying a face region in the image and determining the position of the face region in the colour space, and using the position of the face region to set the skin region. This allows more accurate identification of hand candidates, as it is likely that a subject's body part will be of similar tone to their face. It may also comprise the step of denoising the regions thus identified, typically by removing any internal contours within each region of skin colour and by disregarding any skin-colour areas smaller than a threshold. This enables the method to disregards any artefacts or areas that are unlikely to be body parts, because they are not skin-coloured.

The step of identifying regions of interest in the initial image may comprise defining a bounding area within which the skin-colour regions are found. For example, the method may define each region of interest to be a rectangle within the image that contains a skin-colour region.

The step of extracting image features in the regions of interest in the initial image may comprise extracting image texture features indicative of the texture of the image at the associated point in the image. The step may comprise the use of a feature detection algorithm that detects local gradient extreme values in the image, and for those points provides a descriptor indicating of the texture of the image. An example of such an algorithm is the algorithm proposed in the article Herbert Bay, Andreas Ess, Tinne Tuytelaars, Luc Van Gool, “SURF: Speeded Up Robust Features”, Computer Vision and Image Understanding (CVIU), Vol. 110, No. 3, pp. 346-359, 2008, the teachings of which are incorporated by reference. When applied to the regions of interest, this algorithm will generate as the image features a set of points of interest and a descriptor of the image texture for each point. The image texture descriptors may be a multi-dimensional vector within a multi-dimensional vector space.

The step of extracting image features for the second image of each pair may also comprise the extraction of image texture features in the second image. As such, the step may comprise the use of the same feature detection algorithm. The algorithm discussed above is particularly repeatable, in that it will generally produce the image features for the same features between successive images, even if that feature has been rotated in the plane of the image or scaled. This is useful in the present case when the features of interest are necessarily moving as the subject makes the gesture to be tracked.

The step of determining matches in the second image may comprise the step of determining the distance in the vector space between the vectors representing the texture for all the pairs comprising one image feature from the first image and one image feature from the second image. For each image feature in the second image, the pairing that has the lowest distance in vector space, is determined to be matched; typically, a match will only be determined if a ratio between the lowest distance and the second lowest distance is lower than a threshold.

The range of displacements may have both an upper and lower bound. The range of displacements may be predetermined. Alternatively, the range may be calculated dependent upon according to the size of each region of interest in the first image, the specification of the video (for example, the image size), and an average displacement of matched image features of a previous pair of images. This last feature is advantageous, as it will cause the method to concentrate upon image features that are moving at a speed consistent with previous motion.

The step of determining the regions of interest in the second image may comprise determining the position of the image features in the second image which match to the image features within a region of interest in the first image. This step may then comprise defining a bounding area within which the image features in the second image are found; for example, a bounding rectangle containing all of those image features. This step may also comprise enlarging the bounding area to form an enlarged bounding area enclosing the image features and additionally a margin around the edge of the bounding area. Doing so increases the likelihood that the target body part is still within the enlarged bounding area. The bounding area may be enlarged in all directions, or may be preferentially enlarged in the direction of movement of the region of interest.

The step of determining the direction of movement of the regions of interest may comprise determining the predominant movement direction of the points in the second image which match to the points within the region of interest in the first image. The direction of movement may be quantised; typically, we have found between 6 and 36 different directions to be both sufficient and produce good results; in the preferred embodiment there are 18 possible directions determined. The determination of the predominant movement direction may be weighted, so that points closer to the centre of the region of interest have more effect on the determination of the direction.

The method may comprise the step of splitting a region of interest in the second image if a clustering algorithm indicates that the matched image features are separated into separate clusters within the region of interest, and a distance between the clusters is larger than a threshold. Such a situation indicates there are multiple moving objects in this region, and as such the region of interest can split into multiple regions of interest to track those multiple objects accordingly.

The method may comprise capturing the images with a camera. The remaining steps in the method may be carried out on a computer, to which the camera may be coupled.

The first and second images in each pair of images may be immediately successive images captured. Alternatively, the method may comprise discarding images between the first and second images to vary the frame rate; for example, a given number of images, such as one, two or three, may be discarded between each first and second image.

The method may also comprise classifying the movement of the regions of interest by providing the series of directions of movement for each pair of images to a classifier. The method may comprise smoothing the series of directions to remove rapid changes in direction.

The body part may be a hand, or may be another body part, such as a head, whole limb or even the whole body.

The method may also comprise, should there be no regions of interest remaining in a second image, the step of determining whether a given shape is visible in the second image, and if so, setting a region of interest to include the shape. Thus, if the method loses the gesture, the user can position their hand in a pre-determined shape so that the method can re-acquire the user's hand.

According to a second aspect of the invention, there is provided a method of classifying a gesture, such as a hand gesture, based upon a time-ordered series of movement directions each indicating the direction of movement of a body part in a given frame of a stream of captured images, the method comprising comparing the series of movement directions with a plurality of candidate gestures each comprising a series of strokes, the comparison with each candidate gesture comprising determining a score for how well the series of movement directions fits the candidate gesture.

The score may comprise at least one, but preferably all of the following components:
a first component indicating the sum of the likelihoods of the ith frame being a particular stroke sₙ;
a second component indicating the sum of the likelihoods that in the ith frame, the gesture is the candidate gesture given that the stroke is stroke sₙ;
a third component indicating the sum of the likelihoods that in the ith frame, the gesture is the candidate gesture given that the stroke in this frame is sₙ and the stroke in the previous frame is a particular stroke sₘ.

This has been found to function particularly well; in particular it reliably and accurately classifies the tracks generated by the method of the first aspect of the invention. The method may indicate which of the candidate gestures has the highest scores.

The method may comprise decomposing the candidate gestures into a set of hypothetical strokes. These strokes will help the classifier to produce the score for input movement directions vectors.

The method may comprise the use of Hidden Conditional Random Fields, the Conditional Random Fields, the Latent Dynamic Conditional Random Fields and Hidden Markov Model.

The method may comprise generating the series of movement directions by carrying out the method of the first aspect of the invention. For a given set of captured images, the method may comprise generating multiple time-ordered series of movement directions with different frame rates, and determining the scores for different frame rates. The gesture with the highest score across all frame rates may then be classed as the most likely.

The method may comprise determining the score by training against a plurality of time-ordered series of movement directions for known gestures. Thus, the algorithm can be trained.

The method may comprise the determination of hand position during the gesture, and the score taking into account the position of the user's hand. As such, hand position (open, closed, finger position, etc) can be used to distinguish gestures.

The method may be implemented on a computer.

The gesture may be with a hand, or may be with another body part, such as a head, whole limb or even the whole body.

According to a third aspect of the invention, there is provided a computer having a processor and storage coupled to the processor, the storage carrying program instructions which, when executed on the processor, cause it to carry out the methods of the first or second aspects of the invention.

The computer may be coupled to a camera, the processor being arranged so as to capture images from the camera.

There now follows, by way of example only, embodiments of the invention described with reference to the accompanying drawings, in which:

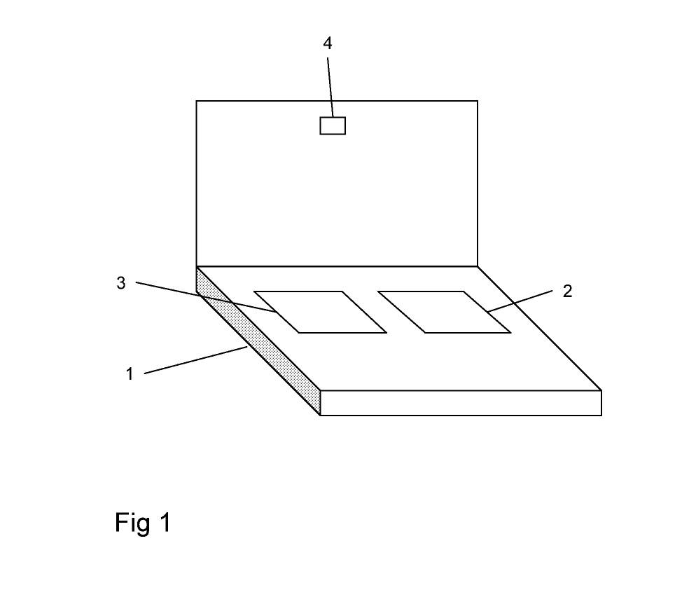

FIG. 1 shows a perspective view of a computer used to implement an embodiment of the invention;

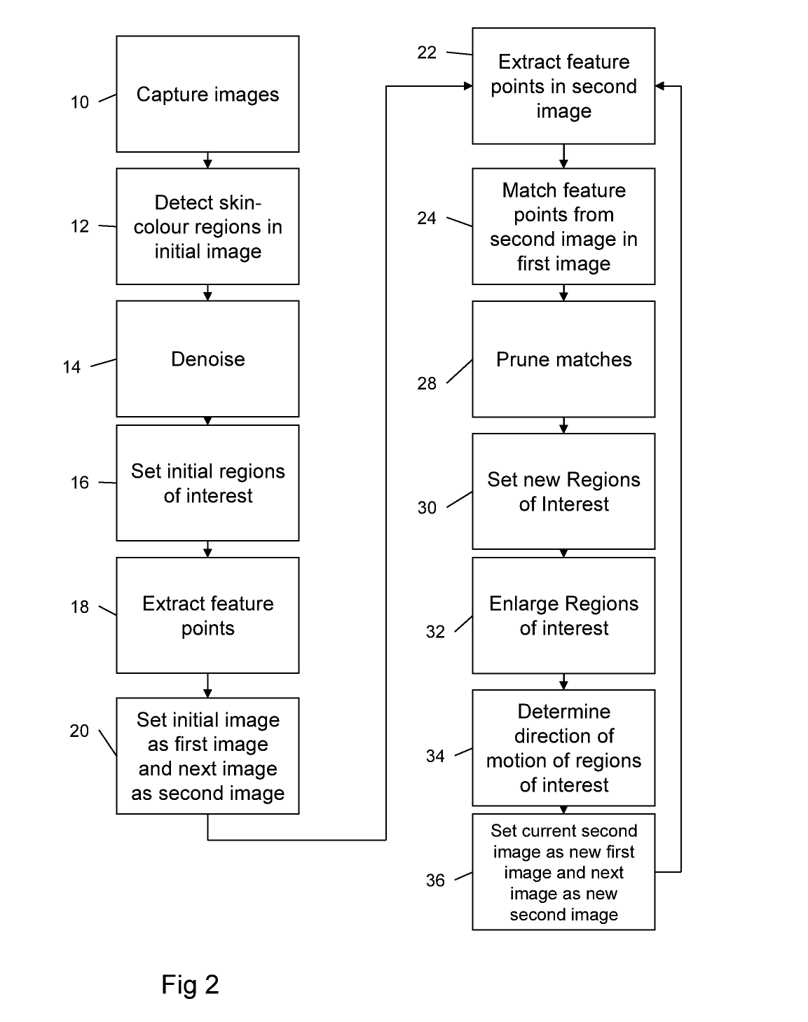

FIG. 2 shows a flowchart showing the operation of the tracking method of the first embodiment of the invention;

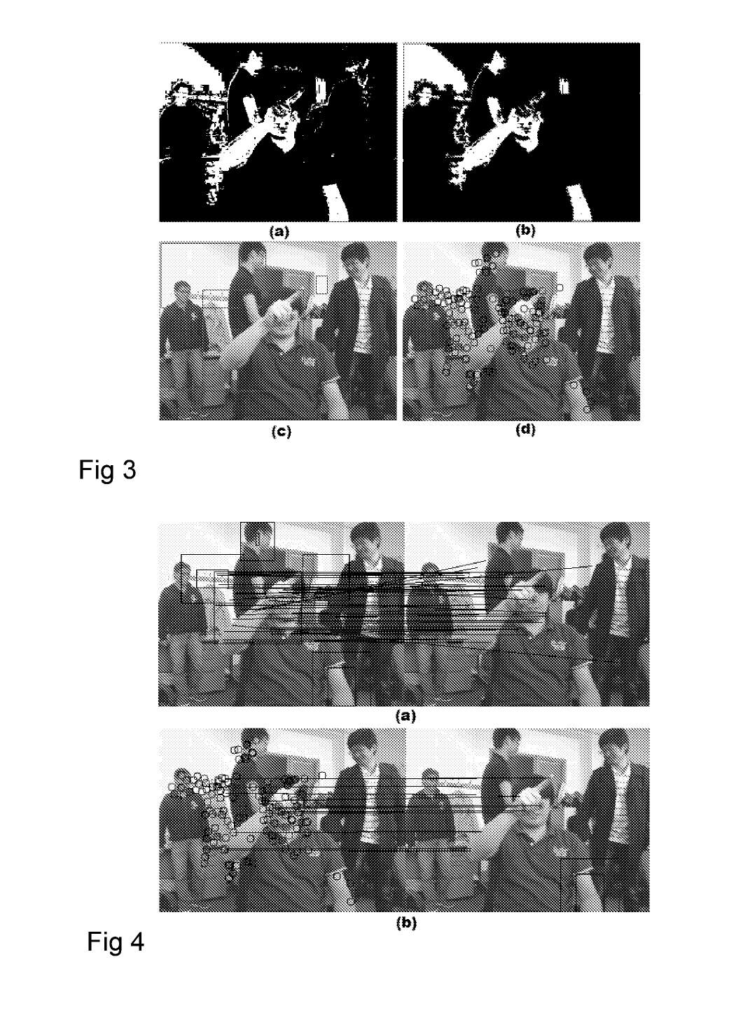

FIG. 3 shows the processing of an initial image through the tracking method of FIG. 2;

FIG. 4 shows the processing of a subsequent pair of images through the tracking method of FIG. 2;

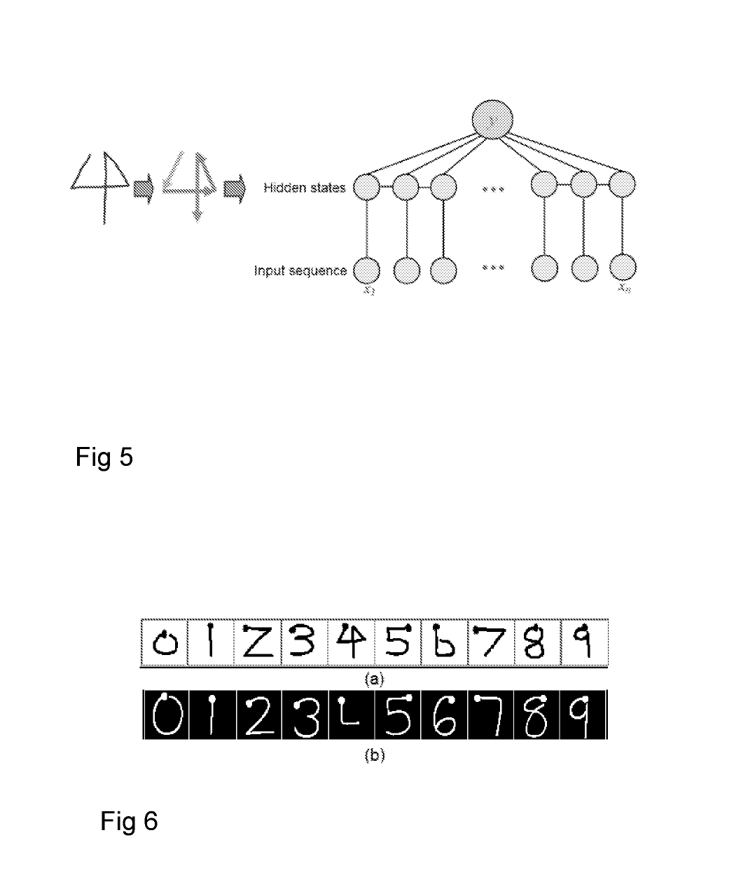

FIG. 5 shows the classifier method of the embodiment of the invention; and

FIG. 6 shows some sample gestures which can be classified by the classifier method of FIG. 5.

FIG. 1 of the accompanying drawings shows a computer 1 that can be used to implement a hand gesture recognition method in accordance with an embodiment of the invention. The computer 1 is depicted as a laptop computer although a desktop computer would be equally applicable. The computer 1 can be a standard personal computer, such as are available from such companies as Apple, Inc or Dell, Inc. The computer 1 comprises a processor 2 coupled to storage 3 and a built-in camera 4.

The camera 4 is arranged to capture images of the surrounding area and in particular of the user of the computer 1. The camera 4 transmits the images to the processor 2. The storage 3, which can comprise random access memory and/or a mass storage device such as a hard disk, stores both data and computer program instructions, including the instructions required to carry out this method. It also carries program instructions for an operating system such as Microsoft® Windows®, Linux® or Apple® Mac OS X®.

The method carried out by the computer 1 is shown in FIG. 2 of the accompanying drawings. In the first step 10, colour images are captured using the camera 4. The subsequent processing of the images (the remaining steps in the flowchart) can be carried out subsequent to the images being captured, or in parallel with the capturing of the images as each image becomes available.

In the second step 12, skin-colour regions within the first image captured are identified. This comprises the detection of a face within the first image, using the Viola-Jones face detector, (Paul Viola, Michael J. Jones, Robust Real-Time Face Detection, International Journal of Computer Vision, Volume 57, page. 137-154, 2004.). The position of the pixels making up the face within a hue-saturation-value (HSV) colour space are determined and an average colour space position taken. The resultant position is then expanded one standard deviation from the mean value to provide a volume within HSV space corresponding to the subject's face. Given that the subject's hands are also likely to be of similar tone, a pixel is determined to be skin tone if it falls within this expanded colour space volume.

FIG. 3(a) shows the identified areas within a sample image as white, with the remaining areas as black; closed areas of skin-colour are then determined. At step 14, the identified areas are denoised, in that any interior contours (that is, areas not determined to be skin within areas of skin-colour) and any areas smaller than a threshold are disregarded. FIG. 3(b) shows the results of denoising the image at FIG. 3(a).

At step 16, regions of interest within the image are determined. In this step, each denoised area of skin colour is surrounded by the smallest possible bounding rectangle. These areas of interest are shown in FIG. 3(c).

At step 18, a feature recognition algorithm is used to determine points of interest within the regions of interest. Any suitable algorithm that generates image features with associated descriptions of the image content (such as image texture) can be used, but in the present embodiment the algorithm described in the paper by Herbert Bay, Andreas Ess, Tinne Tuytelaars, Luc Van Gool, “SURF: Speeded Up Robust Features”, Computer Vision and Image Understanding (CVIU), Vol. 110, No. 3, pp. 346-359, 2008 (the teachings of which are incorporated by reference, and which is available at ftp://ftp.vision.ee.ethz.ch/publications/articles/eth_biwi_00517.pdf) is used. The points thus extracted are shown as circles in FIG. 3(d). The algorithm also generates a multi-dimensional feature vector in a vector space for and to describe each point of interest. In the future, features other than texture may be used, like colour cues, optical flow.

Thus, the first image has been processed. In step 20, preparation is made to process each successive image. Each successive image is compared with its preceding image, so that in the following steps, the first time those steps are carried out it will be with the initial image as the first image in the comparison and the immediately following image as the second image in the comparison. In an improvement, the method can be carried out for different frame rates given the same input images; in such a case, the following steps will be carried out on every Nth image, with N being 1, 2, 3 . . . and the intervening images being skipped.

At step 22, the same feature recognition algorithm, is used to extract points of interest from the second image in the comparison, together with an associated descriptive feature vector.

At step 24, a comparison is made between each point of interest in the second image with each point of interest in the first image. The comparisons are made in the vector space, such that the pairings of points of interest that have the shortest distance between them in the vector space are determined to be matched, where the ratio between the lowest distance and the second lowest distance is lower than a threshold. FIG. 4(a) shows the matches between the initial image (on the left) and the immediately following image (on the right).

At step 28, a pruning process is performed on all matched pairs. Only those pairs with a displacement within a certain range between the matched points interest between the images being compared are preserved. All the matched pairs which are located in stationary regions (e.g. in a face region, where it is the hand that is of interest) or regions that do not move beyond the lower bound of this displacement range are dropped. On the other hand, if a matched point of interest has displaced beyond the upper bound of the displacement range in the next frame, it most likely is a mismatch. This is a reasonable assumption because if an object moves too much within such a short period of time, it is unlikely to be the target hand.

Various displacement ranges have been tested and we found that a default range of between 3 and 40 pixels between frames is empirically feasible. The upper and lower thresholds can be calculated according to the initial size of regions of interest in the first frame, the specification of the video (frame size), and the average displacement of matched points from a or the previous pairs of frames. This allows the method to preferentially track points travelling at a consistent speed between frames.

An example of pruning is shown in FIG. 4(b), where only the accepted matches between points as compared with FIG. 4(a) are shown.

At step 30, the new regions of interest are determined. For each region of interest in the first image, the method determines which points of interest in the region of interest in the first image have matches in the second image. The new region of interest is then set as the smallest bounding rectangle containing the matches in the second image.

At step 32, the new regions of interest are enlarged to ensure that the new regions of interest cover as much of the target hand as possible. The margin (in pixels) by which the regions of interest are enlarged will depend both on the current area A_{i,t} (in pixels) of the i^{th} region of interest in frame t and the number of matches P_{i,t} within the region of interest after pruning, h_{i,0}, w_{i,0} and A_{f} are height, width of the i^{th} region of interest in first frame, and average area of the face region in the first frame, hₛ and wₛ are the height and width of the frame, typically in accordance with the following table:

| Enlarging size | Criteria |
|---|---|
| 0 | A_{i, t} > S_{MR} |
| exp(−A_{i, t}/S_{HA}) * Eᵢ | S_{HA} < A_{i, t} < S_{MR} |
| [exp(−P_{i, t}/10) + 0.3] * Eᵢ | A_{i, t} < S_{HA} and P_{i, t} <= 3 |
| [exp(−P_{i, t}/10)] * Eᵢ | A_{i, t} < S_{HA} and P_{i, t} > 3 |

Where S_{MR}=(hₛ*wₛ)/20 is estimated maximum area of ROIs, S_{HA}=(hₛ*wₛ)/60 is estimated area of hand region.

Ei is the enlarging scale for i^{th} region of interest:

| Enlarging scale factor | Criteria |
|---|---|
| Eᵢ = [(h_{i, 0} + w_{i, 0})/2]*Fₛ | A_{i, 0} < A_{f} * 2.5 |
| Eᵢ = \sqrt{A_{f}} * Fₛ | Otherwise |

Where Fₛ is the enlarging factor correspond to the frame size.

Fₛ=(wₛ/10)*(hₛ/3)

Instead of only keeping the matched points in each of the new enlarged regions of interest, all points of interest within one of the enlarged regions of interest are used for matching to the next image. This allows more points which may relate to the hand candidate being tracked to be matched in the next iteration.

At step 34, the direction of motion of each region of interest between the two images being compared is determined as the hand trajectory feature of the hand candidate. The calculation is determined by taking the dominant movement direction of the matched points for a given region of interest.

Assume we have P matched points of interest between frames t−1 and t after pruning in a region of interest, denoted by Mₜ={ [symbol] Sₜ₋₁¹,Sₜ¹ [symbol] [symbol] Sₜ₋₁²,Sₜ² [symbol] , . . . , [symbol] Sₜ₋₁^{P},Sₜ^{P} [symbol] }, where [symbol] Sₜ₋₁ⁱ,Sₜⁱ [symbol] is the i^{th} pair. The dominant movement direction of the r^{th} region of interest in frame t is defined as:

drt(t,r)=arg max_{d}{q_{d}}_{d=1}^{D} (1)

where {q_{d}}_{d=1}^{D} is the histogram of the movement direction of all matched SURF key point pairs in this region of interest, and d indicates the index of directions. q_{d} is the d^{th} bin of the histogram. Each bin has an angle interval with range α, and D=360°/α. We have tested various values for α and found that 20° produces best results for current experimental databases. Definition of q_{d} is:

$${q}_{d} = C {\sum }_{p = 1}^{p} k ( {‖ {S}_{t}^{p} ‖}^{2} ) δ ( {S}_{t}^{p} , d ) \qquad ( 2 )$$

where, k(x) is a monotonic kernel function which assigns smaller weights to those key SURF points farther away from the centre of this region of interest; δ(Sₜ^{P},d) is the Kronecker delta function which has value 1 if the movement direction of [symbol] Sₜ₋₁^{p},Sₜ^{p} [symbol] falls into the d^{th} bin; and the constant C is a normalisation coefficient defined as

$$C = 1 / {\sum }_{p = 1}^{P} k ( {‖ {S}_{t}^{p} ‖}^{2} ) \qquad ( 3 )$$

The output of this method is therefore a quantised direction for the movement of each region of interest. Because we only use hand movement direction as a hand trajectory feature, the location and speed of hand candidates are not used to describe hand gestures, hence our method does not need to estimate the location and scale of the gestures. The classifier described below can therefore be made to be independent of the speed and scale of the gestures made by a user.

Finally, at step 36, the method repeats from step 22, with the current second image becoming the new first image and the next captured image as the new second image.

In an extension to this embodiment, should there be no regions of interest remaining in a second image at step 30, there method may determine whether a given shape is visible in the second image. If so, a region of interest is set to include the shape. Thus, if the method loses the gesture, the user can position their hand in a pre-determined shape so that the method can re-acquire the user's hand.

In order to classify the track generated by the above tracking method (that is, the series of quantised movement directions, which can be smoothed to remove sudden changes in direction), a hidden conditional random fields (HCRF) classifier is used. Each track, representing the motion of one region of interest in the captured images, is put into a multi-class chain HCRF model as a feature vector, as shown in FIG. 5. The captured images are naturally segmented as one single frame is a single node in the HCRF model.

In one example using the present method, the task for the classifier is recognising two sets of hand-signed digits (as shown in FIG. 6, being a set (a) being derived by the present inventors and referred to as the Warwick Hand Gesture Database and a set (b) being the digits used by the Palm® Graffiti® handwriting recognition system used by the Palm® operating system), we define the hidden states to be the strokes of gestures. We define in total 13 states (that is, strokes) in the HCRF model for our own Warwick Hand Gesture database, and 15 states (strokes) in the Palm Graffiti Digits database (J. Alon, V. Athitsos, Q. Yuan and S. Sclaroff. “A Unified Framework for Gesture Recognition and Spatiotemporal Gesture Segmentation”, IEEE Transactions on Pattern Analysis and Machine Intelligence (PAMI), pp. 1685-1699, September (2009)). FIG. 5 shows four of the 13 states in our Warwick Hand Gesture Database, which form the gesture of digit 4. The optimisation scheme used in our HCRF model is Limited Memory Broyden-Fletcher-Goldfarb-Shanno method (Dong C. Liu, Jorge Nocedal, “On the Limited Memory BFGS Method for Large Scale Optimization”, Mathematical Programming, Springer-Verlag, Volume 45, Issue 1-3, pp. 503-528, 1989). In our experiments, the weight vector θ is initialised with the mean value, and the regularisation factors are set to zero.

As one sequence of the movement direction represents the trajectory direction vector of one hand candidate, a set of captured images can have multiple sequences for multiple hand candidates, and under different frame rate selection patterns. Hence we modified the original HCRF model to suit our special case of multiple sequences for one video. When a new video clip comes in for classification process, every sequence of this video will be evaluated against each gesture class.

The partition function Z(y|x,θ) indicative of the probability of input gesture x being gesture class y for input gesture x, gesture class y, and trained weight vector θ of all feature functions, and set of hidden states (strokes), is calculated for each sequence, which can be understood as the score (partition) between this sequence x and the gesture class y. Then a weighting algorithm (referred to as a Partition Matrix,) is used to calculate the weight of scores for each sequence x, then make final decision on the class label of this input video based on all sequences (different hand candidate, different frame selection pattern) of this video.

The partition matrix of this input video, every cell is the result of HCRF for one sequence with certain frame rate (row:frame selection pattern), from certain ROI (column: hand candidate):

| | ROI 1 | ROI 2 | ROI 3 |
|---|---|---|---|
| Frame Rate 0 | Score(0, 1), | Score(0, 2), | Score(0, 3), |
| | Label(0, 1) | Label(0, 2) | Label(0, 3) |
| Frame Rate 1 | Score(1, 1), | Score(1, 2), | Score(1, 3), |
| | Label(1, 1) | Label(1, 2) | Label(1, 3) |
| Frame Rate 2 | Score(2, 1), | Score(2, 2), | Score(2, 3), |
| | Label(2, 1) | Label(2, 2) | Label(2, 3) |
| Frame Rate 3 | Score(3, 1), | Score(3, 2), | Score(3, 3), |
| | Label(3, 1) | Label(3, 2) | Label(3, 3) |

The sequence with highest partition value among all sequences with same frame selection pattern, will be given higher weight (the highest in a row has higher weight than others in the same row), and every ROI will be given a ROI weight, according to the number of row maximum value this ROI has, and all cells in this ROI (this column), will be given this ROI weight. The final class label assigned to this gesture is the class label with highest weighted sum of partitions over all sequences.

In order to test this method, we conducted two experiments on two databases.

The first experiment is on the Palm Graffiti Digits database used in J. Alon, V. Athitsos, Q. Yuan and S. Sclaroff. “A Unified Framework for Gesture Recognition and Spatiotemporal Gesture Segmentation”, IEEE Transactions on Pattern Analysis and Machine Intelligence (PAMI), pp. 1685-1699, September (2009). This database contains 30 video samples for training, three samples from each of 10 performers that wear gloves. Each sample captures the performer signing digits 0-9 each for once. There are two test sets, the “hard” and “easy” sets. There are 30 videos in the easy set, 3 from each of 10 performers, and 14 videos in the hard set, 2 from each of 7 performers. The content is the same as the training set, except that performers do not wear gloves in the easy set and there are 1 to 3 people moving back and forth in the background in hard set. The specifications of the videos are: 30 Hz, and resolution of 240×320 pixels.

Compared with the method set out by various prior art methods, the present method provided better accuracy on both the easy and the hard set as shown in the following table:

10 Palm Graffiti Digits database

| | Easy set | Hard set |
|---|---|---|
| Correa et al. RoboCup 2009 | 75.00% | N/A |
| Malgireddy et al. CIA 2011 | 93.33% | N/A |
| Alon et al. PAMI 2009 | 94.60% | 85.00% |
| Bao et al. ICEICE 2011 | 52.00% | 28.57% |
| The proposed method | 95.33% | 86.43% |

The methods compared were:
Mauricio Correa, Javier Ruiz-del-Solar, Rodrigo Verschae, Jong Lee-Ferng, Nelson Castillo, “Real-Time Hand Gesture Recognition for Human Robot Interaction”, RoboCup 2009: Robot Soccer World Cup XIII, Springer Berlin Heidelberg, Volume 5949, pp. 46-57, 2010.
Manavender R. Malgireddy, Ifeoma Nwogu, Subarna Ghosh, Venu Govindaraju, “A Shared Parameter Model for Gesture and Sub-gesture Analysis”, Combinatorial Image Analysis, Springer Berlin Heidelberg, Volume 6636, pp 483-493, 2011.
J. Alon, V. Athitsos, Q. Yuan and S. Sclaroff. “A Unified Framework for Gesture Recognition and Spatiotemporal Gesture Segmentation”, IEEE Transactions on Pattern Analysis and Machine Intelligence (PAMI), pp. 1685-1699, September (2009).
Jiatong Bao, Aiguo Song, Yan Guo, Hongru Tang, “Dynamic Hand Gesture Recognition Based on SURF Tracking”, International Conference on Electric Information and Control Engineering—ICEICE (2011).

The results show the percentage of gestures that were correctly identified. On these data, the present method was more accurate than the prior art methods. We believe the improvements are due in part to the fact that, in the analysis of the initial image, only skin-coloured regions are considered as forming the regions of interest. The regions formed by the skin-coloured regions are then tracked through successive frames. This means that skin-coloured areas entering later have less chance of being detected.

For the second experiment, we collected a more challenging database—the Warwick Hand Gesture Database to demonstrate the performance of the proposed method under new challenges. 10 gesture classes as in FIG. 6(a) are defined for our database. This database consists of two testing sets, namely “easy” and “hard” sets. There are 600 video samples for training, 6 samples were captured from each of 10 performers for each gesture. There are 1000 video samples in total for testing. For each gesture, 10 samples were collected from each of 10 performers. The specifications of videos are the same as Palm Graffiti Digits database.

Similar to the Palm Graffiti Digits database, the hard set of our database captures performers wearing short-sleeve tops with cluttered backgrounds. The differences are: No gloves in training set. Instead of 1-3 people, we had 2-4 people moving in the background, and there are new challenges in the clips, including: gesturing hand out of scene during gesture and pause during gesture. Since the work of Bao et al cited above is similar to the proposed method, we compared the performance between these two methods. The results are shown in the following table:

Warwick hand gesture database

| | Easy set | Hard set |
|---|---|---|
| Bao et al. ICEICE 2011 | 57.50% | 18.20% |
| The proposed method | 93.00% | 84.40% |

Again, it can be seen that the present method is an improvement over the prior art methods, even on a more challenging data set.

From our experiments, we have found that the present method can prove more resilient to the following problems:
complex background
still non-skin region in background
moving non-skin region in background
still skin region in background
moving skin region in background
subject wearing short sleeves (and so exposing more skin-coloured areas)
face overlapping with hand
occlusion of hand by other objects
pauses during gesture (particularly if the method preserves the previous regions of interest should no matches be found)
operating hand out of image
hand posture changing during gesture

The present method can be applied in any situation where it desired to determine what gesture a user is making. As such, it can be used in any human-computer interface (HCI) where gestures are used. Examples of such applications include:
Computer games.
Mobile phones (including smart phones) or other portable devices, such as Google® Glasses®. Allows the user to interact with virtual objects, control operating system or so on.
No touch control for laptops, mobile phones, gaming consoles, tablets (including media tablets), smart TV, set top boxes, desktops and any other device with a camera. Can be used to browse images in any convenient situation. One advantageous example is a hospital surgery room, operating theatre or other sterile environment, when it is desirable not to make physical contact with the computer so as to avoid contamination. Also could be used to make calls with a mobile telephone, for example in a car.
Operating machinery. Any machinery can have a camera installed and be controlled by the above method without being touched, such as automated teller machines (ATMs, otherwise known as cash dispensers), cars and other automotive applications, TVs, military drones, robots, healthcare applications, retail applications and marketing applications.

The method described above can be extended by commencing with the initial frame being initially the first frame f₀ to current frame fₜ, if the scores from all gesture classes are lower than a threshold, this part of the video will be treated as garbage gesture. Once some gesture class model produce score higher than the threshold, the method will treat this frame as starting frame of the gesture f₀, until all the scores from all gesture class model are lower than the threshold.

We have appreciated that this method can also be used to distinguish between the gestures of which the method is aware from the training set, and meaningless gestures such as, for example, may occur between gestures.

In another extension to this method, the position of the hand (in the sense of the relative position of the parts of the hand) can be determined whilst generating the trajectory vector. An example of a method that could be used—that uses a similar SURF based method—can be see in the paper by Yao, Yi, and Chang-Tsun Li. “Hand posture recognition using surf with adaptive boosting.” (British Machine Vision Conference 2012), the teachings of which are hereby incorporated by reference. The feature vector can then include, at each interval, the classified hand position from the hand position recognition method. This allows hand position (for example, open palm, closed fist, certain fingers extended or not) to be used alongside the hand gesture (the overall track of movement of the hand) in order to distinguish different gestures, thus increasing the number of distinct gestures that can be made.

1. A method of tracking the position of a body part, such as a hand, in captured images, the method comprising:
capturing colour images of a region to form a set of captured images;
identifying contiguous skin-colour regions within an initial image of the set of captured images;
defining regions of interest containing the skin-coloured regions;
extracting image features in the regions of interest, each image feature relating to a point in a region of interest;
and then, for successive pairs of images comprising a first image and a second image, the first pair of images having as the first image the initial image and a later image, following pairs of images each including as the first image the second image from the preceding pair and a later image as the second image:
extracting image features, each image feature relating to a point in the second image;
determining matches between image features relating to the second image and image features relating to in each region of interest in the first image;
determining the displacement within the image of the matched image features between the first and second images;
disregarding matched features whose displacement is not within a range of displacements;
determining regions of interest in the second image containing the matched features which have not been disregarded;
determining the direction of movement of the regions of interest between the first image and the second image.

2. The method of claim 1, in which the step of identifying contiguous skin-colour regions comprises identifying those regions of the image that are within a skin region of a colour space, optionally in which the skin region is determined by identifying a face region in the image and determining the position of the face region in the colour space, and using the position of the face region to set the skin region.

3. (canceled)

4. The method of claim 1, further including the step of denoising the identified regions of skin colour, optionally in which the denoising comprises removing any internal contours within each region of skin colour and/or disregarding any skin-colour areas smaller than a threshold.

5. (canceled)

6. The method of claim 1, in which the step of identifying regions of interest in the initial image comprises defining a bounding area within which the skin-colour regions are found.

7. The method of claim 1, in which the step of extracting the image features in the regions of interest in the initial image comprises the use of a feature detection algorithm that detects local gradient extreme values in the image and for those points providing a descriptor indicating of the texture of the image, optionally in which the algorithm is the SURF algorithm, and/or optionally in which the step of extracting the image features for the second image of each pair comprises the use of the same feature detection algorithm, and/or optionally in which the step of determining matches in the second image comprises the step of determining the distance in the vector space between the vectors representing the texture for all the pairs comprising one image feature from the first image and one image feature from the second image.

8-10. (canceled)

11. The method of claim 1, in which the step of determining the regions of interest in the second image comprises determining the position of the image features in the second image which match to the image features within a region of interest in the first image.

12. The method of claim 11, in which the step of determining the regions of interest in the second image comprises defining a bounding area within which the image features which match image features in the region of interest in the first image are found in the second image, optionally in which the step of determining the regions of interest in the second image comprises enlarging the bounding area to form an enlarged bounding area enclosing the image features and additionally a margin around the edge of the bounding area.

13. (canceled)

14. The method of claim 11, in which the range of displacements is determined dependent upon an average displacement of matched image features from a previous pair of images.

15. The method of claim 1, in which the step of determining the direction of movement of the regions of interest comprises determining the predominant movement direction of the image features in the second image which match to the image features within the region of interest in the first image, optionally in which the direction of movement is quantised, and/or optionally in which the determination of the predominant movement direction is weighted, so that image features closer to the centre of the region of interest have more effect on the determination of the direction.

16-17. (canceled)

18. The method of claim 1, comprising capturing the images with a camera.

19. The method of claim 1, comprising classifying the movement of the regions of interest by providing the series of directions of movement for each pair of images to a classifier.

20. The method of claim 1, comprising discarding images between the first and second images to vary the frame rate.

21. A method of classifying a gesture, such as a hand gesture, based upon a time-ordered series of movement directions each indicating the direction of movement of a body part in a given frame of a stream of captured images, the method comprising comparing the series of movement directions with a plurality of candidate gestures each comprising a series of strokes, the comparison with each candidate gesture comprising determining a score for how well the series of movement directions fits the candidate gesture.

22. The method of claim 21, in which the score comprises one or more of the following components:
a first component indicating the sum of the likelihoods of the ith frame being a particular stroke sₙ;
a second component indicating the sum of the likelihoods that in the ith frame, the gesture is the candidate gesture given that the stroke is stroke sₙ;
a third component indicating the sum of the likelihoods that in the ith frame, the gesture is the candidate gesture given that the stroke in this frame is sₙ and the stroke in the previous frame is a particular stroke sₘ.

23. The method of claim 21, comprising the use of at least one of a Hidden Conditional Random Fields classifier, the Conditional Random Fields, the Latent Dynamic Conditional Random Fields and Hidden Markov Model.

24. The method of claim 21, comprising generating the series of movement directions by carrying out the method of any of claims 1 to 23.

25. The method of claim 21, in which the method comprises generating multiple time-ordered series of movement directions with different frame rates, and determining the scores for different frame rates.

26. The method of claim 21, comprising determining the calculation of the scores by training against a plurality of time-ordered series of movement directions for known gestures.

27. A computer having a processor and storage coupled to the processor, the storage carrying program instructions which, when executed on the processor, cause it to carry out the method of claim 1.

28. The computer of claim 27, coupled to a camera, the processor being arranged so as to capture images from the camera.
